(19) United States
(12) Patent Application Publication
(10) Pub. No.: US 2026/0267357 A1
(43) Pub. Date: Sep. 10, 2026

(54) CONSTANT-SPACING CONNECTED PLATOONS WITH ROBUSTNESS TO COMMUNICATION DELAYS

(71) Applicants: University of Washington, Seattle, WA (US); University of Portland, Portland, OR (US)

(72) Inventors: Yudong Lin, Seattle, WA (US); Santosh Devasia, Seattle, WA (US); Anuj Tiwari, Seattle, WA (US); Brian Fabien, Portland (UA)

(73) Assignees: University of Washington, Seattle, WA (US); University of Portland, Portland, OR (US)

(21) Appl. No.: 18/871,769

(22) PCT Filed: Jun. 9, 2023
(86) PCT No.: PCT/US2023/068257

§ 371 Date: Dec. 4, 2024

Related U.S. Application Data
(60) Provisional application No. 63/351,764, filed on Jun. 13, 2022.

(51) Int. Cl. G05D 1/695; G01S 13/931; G05D 1/698; G05D 105/22; G05D 107/13

(52) U.S. Cl. CPC G05D 1/696; G01S 13/931; G05D 1/6985; G01S 2013/9325; G05D 2105/22; G05D 2107/13

(57) ABSTRACT

In some embodiments, a method of controlling a follower vehicle in a vehicle platoon is provided. A follower vehicle controller in the follower vehicle determines a centralized control command based on centralized control information. The follower vehicle controller determines a local control command based on local sensing information using a delayed self reinforcement (DSR) technique. The follower vehicle controller applies weights to the centralized control command and the local control command. The follower vehicle controller combines the weighted centralized control command and the weighted local control command to create a combined control command. The follower vehicle controller uses the combined control command to control a speed of the corresponding follower vehicle.

### CROSS-REFERENCE TO RELATED APPLICATION

This application claims the benefit of Provisional Application No. 63/351,764, filed Jun. 13, 2022, the entire disclosure of which is hereby incorporated by reference herein for all purposes.

### BACKGROUND

Longitudinal cruise control with constant spacing policy (CSP) enables platoons with small inter-vehicle distances, resulting in improved fuel efficiency, and increased traffic throughput. However, it is well-known that constant spacing cannot be maintained together with string stability when using decentralized predecessor-follower (PF) methods which rely only on local sensing information about the preceding vehicle.

Predecessor-leader-follower (PLF), with centralized communication from the leader vehicle to the followers, resolves the problem and enables constant spacing with string stability. However, the performance of the resulting connected vehicle system (CVS) is vulnerable to communication issues. For example, large communication delays (e.g., on the order of about 2.5 seconds, compared to a more typical communication delay on the order of about 0.5 seconds) can lead to slower oscillatory convergence to consensus, and communication loss can lead to large spacing errors. Large communication delay and communication loss can be caused by environmental jamming or by transmission over long distances. For example, in locations with a high rate of jamming, such systems typically reduce the packet delivery rate in order to reject unwanted messages. Furthermore, large transmission and receiving distances in the hundreds of meters, which is anticipated for truck platooning on highways, can greatly increase the path loss and communication delay of vehicle to vehicle communication. Therefore, there is a need to develop PLF protocols that maintain robust performance in the presence of such communication problems.

Previous works have addressed the issue of small communication delays or short periods of communication loss on the performance of the connected vehicle system (CVS). For example, previous work has established an upper bound of communication delay to maintain string stability that depends on the vehicle dynamics and can be found numerically or analytically depending on the selected headway time. Furthermore, previous work has analytically derived sufficient conditions on the communication delay to guarantee internal stability and string stability. However, for large communication delays, even with string stability and internal stability, the performance of such techniques in terms of settling time (for converging to consensus) can be large.

Also, short term communication loss can be addressed using estimation techniques to infer the lost centralized command. However, such methods are not applicable for large delays in communication or when communication is lost for long periods of time. In particular, when communication is lost for extended periods of time, the PLF structure degrades to the PF structure with only the decentralized protocol, which cannot maintain both constant spacing and string stability as discussed before. Thus, current CSP has challenges when dealing with large communication delays or loss in communication for extended periods of time.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a control system for a vehicle platoon is provided. The control system comprises a lead vehicle controller installed in a lead vehicle and one or more follower vehicle controllers. The lead vehicle controller is configured to determine centralized control information, and transmit the centralized control information to the one or more follower vehicle controllers. Each of the one or more follower vehicle controllers is installed in a corresponding follower vehicle and is configured to receive the centralized control information from the lead vehicle controller, determine a centralized control command based on the centralized control information, receive local sensing information from a distance sensor of the corresponding follower vehicle, determine a local control command based on the local sensing information using a delayed self reinforcement (DSR) technique, apply weights to the centralized control command and the local control command, combine the weighted centralized control command and the weighted local control command to create a combined control command, and use the combined control command to control a speed of the corresponding follower vehicle.

In some embodiments, a method of controlling a follower vehicle in a vehicle platoon is provided. A follower vehicle controller in the follower vehicle determines a centralized control command based on centralized control information. The follower vehicle controller determines a local control command based on local sensing information using a delayed self reinforcement (DSR) technique. The follower vehicle controller applies weights to the centralized control command and the local control command. The follower vehicle controller combines the weighted centralized control command and the weighted local control command to create a combined control command. The follower vehicle controller uses the combined control command to control a speed of the corresponding follower vehicle.

In some embodiments, a non-transitory computer-readable medium having computer-executable instructions stored thereon is provided. The instructions, in response to execution by one or more processors of a follower vehicle controller, cause the follower vehicle controller to perform a method as described above.

In some embodiments, a follower vehicle controller configured to perform a method as described above is provided.

In some embodiments, a follower vehicle having a follower vehicle controller configured to perform a method as described above is provided.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a block diagram that illustrates a non-limiting example embodiment of a vehicle according to various aspects of the present disclosure.

FIG. 2 is a schematic illustration of a non-limiting example embodiment of a vehicle platoon according to various aspects of the present disclosure.

FIG. 3 illustrates a non-limiting example embodiment of a control law according to various aspects of the present disclosure.

FIG. 4 is a schematic illustration of the predecessor-leader-follower (PLF) with delayed-self-reinforcement (DSR) control strategy for follower vehicles in a vehicle platoon according to various aspects of the present disclosure.

FIG. 5 is a flowchart that illustrates a non-limiting example embodiment of a method of controlling a vehicle platoon according to various aspects of the present disclosure.

FIG. 6A-FIG. 6C are charts that illustrate simulated mixed traffic capacity with V=34 mph.

FIG. 7A and FIG. 7B are charts that illustrate the standard deviation of the simulated mixed traffic capacity.

### DETAILED DESCRIPTION

The current disclosure provides a PLF protocol that enlarges the acceptable upper bound of communication delays for maintaining string stability and constant spacing, and reduces the constant spacing error when CVS degrades to PF protocol due to communication loss. In some embodiments of the present disclosure, a delayed self reinforcement (DSR) approach is used for the decentralized part of the PLF. The DSR approach seeks to implement the ideal, non-delayed centralized command which results in ideal platooning from the current and delayed local sensing information, and also results in improved cohesion. Since the DSR approximates the ideal centralized command, it leads to low spacing errors in the platoon with large communication delays, even when the communication is lost.

Contributions of the present disclosure include development of a new blended PLF with both (a) decentralized DSR and (b) centralized communication as opposed to purely decentralized communication; determination of conditions for the blended DSR-based, constant-spacing PLF to guarantee internal stability and string stability with delayed centralized command and loss of communication, along with quantification of the steady state spacing error under communication loss; and illustration of the DSR parameter selection and impact under different communication conditions using a simulated example.

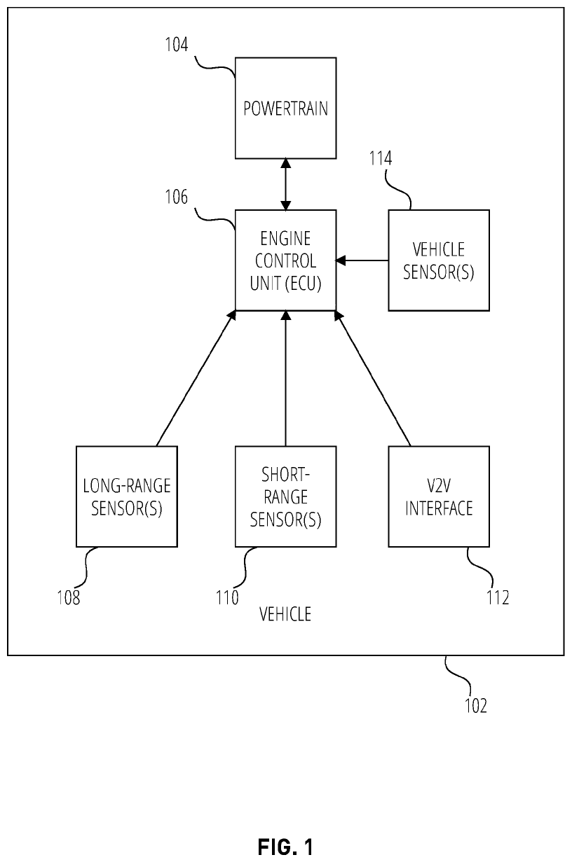

FIG. 1 is a block diagram that illustrates a non-limiting example embodiment of a vehicle according to various aspects of the present disclosure. The vehicle 102 may be any type of vehicle configured to operate in a vehicle platoon 200 as described herein. In some embodiments, the vehicle 102 may be a Class 8 truck. In some embodiments, the vehicle 102 may be another type of vehicle likely to transit long distances in coordination with other vehicles, including but not limited to a bus, a van, a recreational vehicle, a passenger car, or any other type of vehicle. In some embodiments, the vehicle 102 may be configured to operate on a surface other than a roadway, including but not limited to a train car or a hyperloop capsule.

As shown, the vehicle 102 includes a powertrain 104, an engine control unit (ECU 106), one or more vehicle sensors 114, one or more long-range sensors 108, one or more short-range sensors 110, and a V2V interface 112.

The powertrain 104 may include one or more motors, one or more drivetrain components including but not limited to wheels, axles, driveshafts, gear boxes, torque converters, transmissions, batteries, and/or other components for propelling the vehicle 102. The powertrain 104 may also include one or more brakes, flywheels, regenerative braking systems, or other devices for reducing speed of the vehicle 102. In some embodiments, the powertrain 104 may use internal combustion technology, electric propulsion technology, other propulsion technologies, and/or combinations thereof.

The one or more vehicle sensors 114 may include any type of sensor that provides information to the ECU 106 regarding a state of the vehicle 102. For example, the vehicle sensors 114 may include one or more of a vehicle speed sensor, a positioning sensor (such as a global positioning system (GPS) sensor), an engine speed sensor, a fuel tank sensor, a gearbox status sensor, and/or any other type of vehicle sensor.

The one or more long-range sensors 108 are configured to determine measurements of relative distances between a given vehicle and a preceding vehicle. In some embodiments, the long-range sensors 108 may include one or more of a two-dimensional camera, a three-dimensional camera, a radar, a lidar, or any other suitable type of sensing technology (or combinations thereof).

In some embodiments, the one or more short-range sensors 110 may also be configured to determine measurements of relative distances between a given vehicle and a preceding vehicle, but over a shorter distance than the long-range sensors 108. In some embodiments, the short-range sensors 110 may include one or more of a two-dimensional camera, a three-dimensional camera, a radar, a lidar, an ultrasonic sensor, or any other suitable type of sensing technology (or combinations thereof).

In some embodiments, a similar type of sensor may be used as a long-range sensor 108 and a short-range sensor 110, but with a different configuration. For example, a radar sensor may be configured as a long-range sensor 108 by using a narrow opening angle (thus providing information from a narrow area but a long distance), or as a short-range sensor 110 by using a wide opening angle (thus providing information from a wide area but a short distance). Typically, a short-range sensor 110 is a sensor configured to have a maximum sensing distance in a range of 27-33 meters, such as 30 meters, whereas a long-range sensor 108 is a sensor configured to have a maximum sensing distance in a range of 110-130 meters, such as 120 meters, or greater.

In some embodiments, the V2V interface 112 is a wireless communication interface by which the vehicle 102 may communicate with other vehicles in the vehicle platoon 200. Typically, in a vehicle platoon 200 as disclosed herein, the vehicle 102 will use the V2V interface 112 to receive centralized control commands from the lead vehicle 202, and/or control commands being implemented by one or more other vehicles in the vehicle platoon 200 (e.g., one or more predecessor vehicles), and may use the V2V interface 112 to transmit control commands being implemented by the vehicle 102. In a case where the vehicle 102 is the lead vehicle 202, the V2V interface 112 may be used to transmit centralized control commands to the follower vehicles.

The ECU 106 is configured to receive signals from the long-range sensors 108, the short-range sensors 110, and the V2V interface 112, along with signals from one or more vehicle sensors 114, in order to determine control commands for the powertrain 104. For example, the ECU 106 may determine a desired absolute or relative speed for the vehicle 102, and may transmit commands to one or more components of the powertrain 104 in order to cause the vehicle 102 to operate as desired by the control strategy.

In some embodiments, the ECU 106 includes a memory, one or more communication interfaces to communicate with the other components of the vehicle 102, and a processor for executing instructions stored in the memory, processing information received from the other components of the vehicle 102, and transmitting instructions to the other components of the vehicle 102. In some embodiments, the memory may be a firmware or other reprogrammable computer-readable medium. In some embodiments, the processor and instructions may be provided together by an ASIC, an FPGA, or another computing device in which the instructions are provided in hardware.

In some embodiments, functionality of the ECU 106 may be compartmentalized into separate components. For example, the platoon speed control functionality may be provided by a lead vehicle controller or follower vehicle controller of the ECU 106, and instructions for operating the powertrain 104 to implement commands determined by the lead vehicle controller or follower vehicle controller may be generated by a speed controller of the ECU 106. In some embodiments, multiple physical ECUs may be provided which collaboratively provide the functionality described herein.

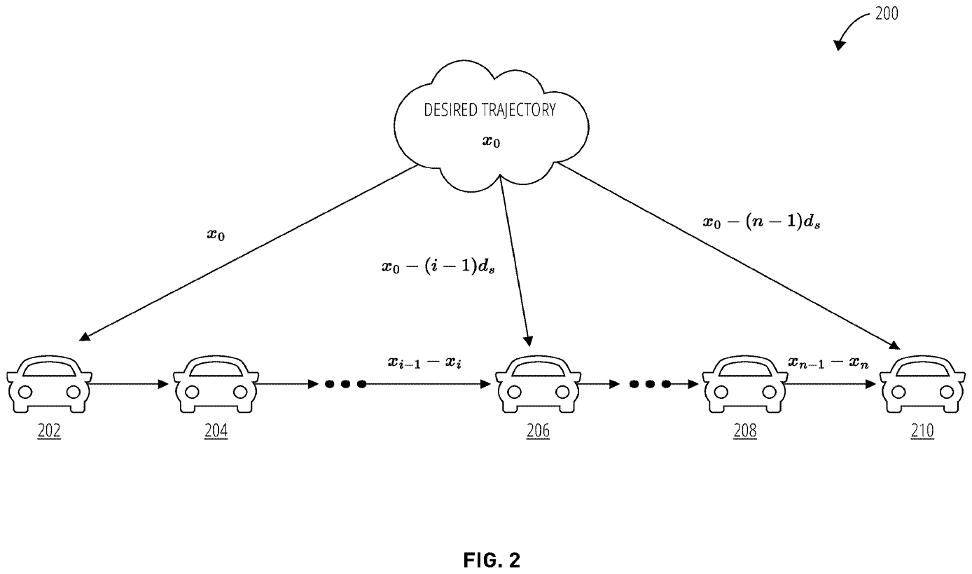

FIG. 2 is a schematic illustration of a non-limiting example embodiment of a vehicle platoon according to various aspects of the present disclosure. In the illustrated vehicle platoon 200, there are n vehicles, starting with a lead vehicle 202 (vehicle 1), and followed by a plurality of follower vehicles 204-210, including the illustrated first follower vehicle 204 (vehicle 2), second follower vehicle 206 (vehicle i), third follower vehicle 208 (vehicle n-1), and fourth follower vehicle 210 (vehicle n). The presence of four follower vehicles is illustrated for discussion purposes only. In some embodiments, more or fewer follower vehicles may be present in the vehicle platoon 200. Each of the vehicles in the vehicle platoon 200 may include one or more components of the vehicle 102 as illustrated in FIG. 1.

In the vehicle platoon 200, there is a single lead vehicle 202. Each other vehicle in the vehicle platoon 200 is a follower vehicle, and the vehicle immediately preceding a given vehicle is the predecessor vehicle to that vehicle (e.g., third follower vehicle 208 is a predecessor vehicle to fourth follower vehicle 210). Each follower vehicle behind the first follower vehicle 204 obtains centralized information about its desired position (i.e., \tilde{x}_{d,i}(t)=x₀(t)−(i−1)dₛ), where x₀ is the desired position of the lead vehicle 202, and decentralized local sensing information of its own position xᵢ and the relative positioning error δᵢ=xᵢ₋₁−xᵢ with respect to its predecessor vehicle.

Each vehicle's input-to-output dynamics can be made homogenous using input-output feedback linearization even if the original dynamics is heterogenous and nonlinear to obtain in the Laplace domain

$${\tilde{L}}_{i} ( s ) = \frac{{\tilde{x}}_{i} ( s )}{{\tilde{u}}_{i} ( s )} = \frac{1}{{s}^{{m}_{i}}} \qquad ( 1 )$$

where \tilde{x}ᵢ∈ [symbol] and ũᵢ∈ [symbol] are the output position and input of the i^{th} vehicle in the system, and mᵢ is the relative degree. Stable pole-zero cancellation is achieved by selecting the control law

$${\tilde{u}}_{i} ( s ) = {C}_{ff , i} ( s ) {u}_{i} ( s ) - {C}_{fb , i} ( s ) {\tilde{x}}_{i} ( s ) \qquad ( 2 )$$

with feedback controllers C_{ff,i}, C_{fb,i}

$${C}_{ff , i} ( s ) = {s}^{{m}_{i} - 1} + {k}_{1} {s}^{{m}_{i} - 2} + … + {k}_{{m}_{i} - 1} , \qquad ( 3 )$$

$${C}_{fb , i} ( s ) = {k}_{1} {s}^{{m}_{i} - 1} + {k}_{2} {s}^{{m}_{i} - 2} + … + {k}_{{m}_{i} - 1} s \qquad ( 4 )$$

resulting in a first-order closed-loop dynamics Lᵢ(s):

$$\begin{matrix}{L}_{i} ( s ) = \frac{{\tilde{x}}_{i} ( s )}{{u}_{i} ( s )} = \frac{{\tilde{L}}_{i} ( s ) {C}_{ff , i} ( s )}{1 + {\tilde{L}}_{i} ( s ) {C}_{fb , i} ( s )} \\ = \frac{( {s}^{{m}_{i} - 1} + {k}_{1} {s}^{{m}_{i} - 2} + {k}_{2} {s}^{{m}_{i} - 3} + … {k}_{{m}_{i} - 1} )}{s ( {s}^{{m}_{i} - 1} + {k}_{1} {s}^{{m}_{i} - 2} + {k}_{2} {s}^{{m}_{i} - 3} + … {k}_{{m}_{i} - 1} )} \\ = \frac{1}{s} = L ( s ) .\end{matrix} \qquad ( 5 )$$

The controller gains k₁, . . . , kₘ_{ᵢ}₋₁ are designed to avoid unstable pole-zero cancellations by ensuring that the cancelled polynomial pᵢ(s)=s^{m}^{ᵢ}⁻¹+k₁s^{m}^{ᵢ}⁻²+ . . . +kₘ_{ᵢ}₋₁ has roots in the open left-half of the complex-plane. For example, if each individual vehicle dynamics is a second-integrator model \tilde{L}ᵢ(s)=s⁻², then the controllers

$${C}_{ff , i} ( s ) = s + {k}_{1} , {C}_{fb , i} ( s ) {k}_{1} s \qquad ( 6 )$$

with k₁>0, would achieve the reduction to the single-integrator system in Equation (5).

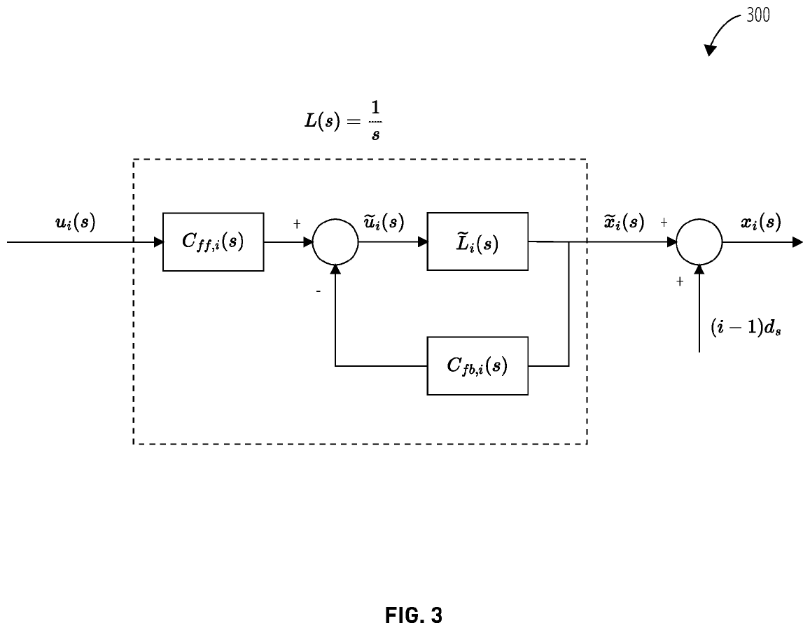

FIG. 3 illustrates a non-limiting example embodiment of a control law according to various aspects of the present disclosure. In the control law 300, stable pole-zero cancellations using the controllers C_{ff,i} and C_{fb,i} from Equations (3) and (4) reduces the vehicle dynamics \tilde{L}ᵢ to a single-integrator system L depicted inside the dashed box. xᵢ is the deviation from the ideal spacing (i−1)dₛ with respect to the lead vehicle, as discussed below in Equation (10).

To maintain constant spacing in a platoon, an ideal scenario is for each vehicle i in the set of positive integers [symbol] , i.e., i∈ [symbol] to receive information about its desired position \tilde{x}_{d,i} from a virtual source as

$${\tilde{x}}_{d , i} ( t ) = {x}_{0} ( t ) - ( i - 1 ) {d}_{s} \qquad ( 7 )$$

where x₀ is the desired position of the lead vehicle 202 i=1 and dₛ is the desired spacing between adjacent vehicles. Then, each vehicle in the vehicle platoon 200 applies the control law

$${u}_{i} ( t ) = - α ( {\tilde{x}}_{i} ( t ) - {\tilde{x}}_{d , i} ( t ) ) \qquad ( 8 )$$

and α>0 defines the time constant

$$1 / α .$$

The resulting dynamics can be written as, from Equations (5) and (8),

$${\dot{x}}_{i} ( t ) = - α {x}_{i} ( t ) + α {x}_{0} ( t ) = {u}_{c , i} ( t ) \qquad ( 9 )$$

where the position xᵢ is defined as the deviation from the ideal spacing with respect to the lead vehicle 202, i.e.,

$${x}_{i} ( t ) = {\tilde{x}}_{i} ( t ) - ( - ( i - 1 ) {d}_{s} ) = {\tilde{x}}_{i} ( t ) + ( i - 1 ) {d}_{s} \qquad ( 10 )$$

It is assumed that all vehicles have the desired spacing initially, i.e., xᵢ(0)=x₀(0) for all i∈ [symbol] . With the ideal centralized input u_{c,i} in Equation (9), all vehicle responses are the same, i.e., xᵢ(t)=xⱼ(t), and therefore, the constant-spacing policy (CSP) can be maintained for a given desired position trajectory x₀. In matrix form, the ideal centralized control in Equation (9) can be written as:

$$\dot{X} ( t ) = - α IX ( t ) + α1 {x}_{0} ( t ) = {u}_{c} ( t ) \qquad ( 11 )$$

where X=[x₁, x₂, . . . , xₙ]^{T}, I is the n×n identity matrix, and 1 is an n×1 vector of ones.

The ideal centralized approach in Equation (11) can be approximated to be decentralized (e.g., where only the lead vehicle has access to the desired trajectory x₀) using the delayed self reinforcement (DSR), as described below. Multiplying Equation (11) with βK, where β is the DSR gain and K is the pinned graph Laplacian of the CVS network without the virtual source, with nonzero off-diagonal elements K_{i,j}=−1 only if vehicle i receives information (through sensing or communication) about vehicle j where i≠j, and the diagonal elements are K_{i,i}=Bᵢ−ΣⱼK_{i,j} with nonzero Bᵢ=1 only if vehicle i receives information about the desired position x₀ from the virtual source i=0, the ideal centralized dynamics can be rewritten as

$$β K \dot{X} ( t ) = - αβ KX ( t ) + αβ K 1 {x}_{0} ( t ) \qquad ( 12 )$$

If the CVS connectivity contains information paths from the virtual source node i=0 (providing the desired position information) to each vehicle in the platoon, then the pinned Laplacian K of the graph without the source node i=0 is invertible, i.e., det(K)≠0 from the Matrix-Tree Theorem described by W. T. Tuttle, Graph Theory, Cambridge University Press (2001), incorporated by reference herein for all purposes. Moreover, the vehicles will achieve consensus eventually, i.e., K⁻¹B=1, where B is the source connectivity vector (i.e. row element is nonzero Bᵢ=1 only if vehicle i is connected to the source and is zero otherwise). Finally, adding \dot{X}(t) on both sides of Equation (12) and rearranging, results in

$$\dot{X} ( t ) = ( I - β K ) \dot{X} ( t ) - αβ KX ( t ) + αβ {Bx}_{0} ( t ) . \qquad ( 13 )$$

The DSR approach uses delayed versions of already available information to implement the derivative on the right hand side of Equation (13) as

$$\begin{matrix}\dot{X} ( t ) \approx ( I - β K ) \frac{X ( t ) - X ( t - {τ}_{d} )}{{τ}_{d}} \\ - αβ KX ( t ) + αβ {Bx}_{0} ( t ) \\ = {u}_{dsr} ( t ) .\end{matrix} , \qquad ( 14 )$$

The above DSR approach can be implemented in a decentralized manner, e.g., with source information available only to the lead vehicle 202, and it approximates the performance of the centralized approach when the desired trajectories vary slowly compared to the time delay τ_{d}>0 in Equation (14). One example of an advantage of the DSR approach is that it does not require additional sensing or communication. Rather, current and delayed versions of the sensed signals K X and the vehicle's position xᵢ, already available to the vehicle controller, are sufficient for implementation. The DSR approach to decentralize the ideal cohesive dynamics as in Equation (14) can also be applied even if the homogenous dynamics L in Equation (5) of the vehicle is higher order.

In some embodiments of the present disclosure, the centralized and decentralized DSR approach are blended to achieve good performance even when communication about the desired trajectory x₀ is not always available for all the vehicles in the vehicle platoon 200. With the blended approach, from Equations (11) and (14),

$${\dot{x}}_{i} ( t ) = γ {u}_{dsr , i} ( t - {τ}_{l} ) + ( 1 - γ ) {u}_{c , i} ( t - {τ}_{c} ) , ∀ i \geq 2 \qquad ( 15 )$$

$${\dot{x}}_{1} ( t ) = γ {u}_{dsr , 1} ( t - {τ}_{l} ) + ( 1 - γ ) {u}_{c , 1} ( t - {τ}_{l} ) ,$$

where 0≤γ≤1 is the blending gain, τ_{c}>0 is the communication delay, τₗ>0 is the local sensing delay, and u_{dsr,i} and u_{c,i} are the i^{th} elements of the DSR and centralized control inputs respectively. Since the leader has the source information x₀, the local sensing delay τₗ is applied instead of the communication delay τ_{c} in Equation (15). The blended approach in Equation (15) is referred to herein as PLF with DSR.

Typically, the lead vehicle 202 can compute and generate the source trajectory locally before broadcasting to the follower vehicles. Therefore, the communication delay of the lead vehicle 202 to the source trajectory is assumed to be small, and is considered to be the same as the local sensing delay τₗ.

The time delays τ_{c}, τₗ, τ_{d} can be varying for each vehicle. However, they are assumed to be the same for all vehicles in the vehicle platoon 200 to promote cohesive responses. If the actual delays are different, each vehicle can add intentional buffer delays (as appropriate) to maintain homogeneity in the delays for all vehicles.

Internal Stability: Individual-vehicle transfer functions may be given by:

$${T}_{i} ( s ) = \frac{{x}_{i} ( s )}{{x}_{0} ( s )} \qquad ( 16 )$$

Internal stability of the CVS may be ensured when the real parts of the poles of Equation (16) are negative. Conditions for internal stability of the CVS are developed by finding the transfer functions Tᵢ in Equation (16) of the vehicle responses xᵢ to the desired position of the lead vehicle 202 x₀, and then finding requirements to ensure that the poles of the transfer functions Tᵢ are on the open left half of the complex plane. Each vehicle uses both the relative positioning error (with respect to its predecessor vehicle) and the source positioning error in control, as illustrated in FIG. 2, with the predecessor-leader-follower network, where the associated pinned graph Laplacian K∈ [symbol] in Equation (14) and the source connectivity vector B∈ [symbol] are given by

$$K = [ \begin{matrix}1 & … & & 0 \\ - 1 & 1 & & \\ ⋮ & ⋱ & ⋱ & \\ 0 & … & - 1 & 1\end{matrix} ] , B = [ \begin{matrix}1 \\ 0 \\ ⋮ \\ 0\end{matrix} ] . \qquad ( 20 )$$

The lead vehicle 202 (i=1) state equation with the DSR approach (Equation (14)), for the pinned graph Laplacian K and source connectivity vector B as defined in Equation (20), is found to be

$$\begin{matrix}{\dot{x}}_{1} ( t ) = ( 1 - β ) \frac{{x}_{1} ( t ) - {x}_{1} ( t - {τ}_{d} )}{{τ}_{d}} - αβ ( {x}_{1} ( t ) - {x}_{0} ( t ) ) \\ = {u}_{dsr , 1} ( t ) ,\end{matrix} \qquad ( 21 )$$

and the state equation for the followers i>1 is obtained as

$$\begin{matrix}{\dot{x}}_{i} ( t ) = ( 1 - β ) \frac{{x}_{i} ( t ) - {x}_{i} ( t - {τ}_{d} )}{{τ}_{d}} + β \frac{{x}_{i - 1} ( t ) - {x}_{i - 1} ( t - {τ}_{d} )}{{τ}_{d}} \\ - αβ ( {x}_{i} ( t ) - {x}_{i - 1} ( t ) ) = {u}_{dsr , i} ( t ) .\end{matrix} \qquad ( 22 )$$

The dynamics of the i^{th} vehicle \dot{x}ᵢ(t) can be found by substituting the DSR command from Equations (21), (22) and the centralized command from Equation (11) into the blended protocol in Equation (15) to obtain, in the Laplace domain, for i=1,

$$\frac{{x}_{1} ( s )}{{x}_{0} ( s )} = \frac{{G}_{c 0} ( s )}{s - ( 1 - β ) {G}_{m} ( s ) + {G}_{c 0} ( s )} = \frac{{G}_{c o} ( s )}{{D}_{0} ( s )} = {T}_{1} ( s ) , \qquad ( 23 )$$

where T₁(s) is the position-transfer function for the lead vehicle 202, and for the follower vehicles, i≥2,

$$\begin{matrix}{x}_{i} ( s ) = \frac{{G}_{c} ( s ) {x}_{0} + {G}_{f} ( s ) {x}_{i - 1}}{s - {G}_{m} ( s ) + {G}_{f} ( s ) + {G}_{c} ( s )} \\ = \frac{{G}_{c} ( s ) {x}_{0} + {G}_{f} ( s ) {x}_{i - 1}}{D ( s )}\end{matrix} , \qquad ( 24 )$$

$$with$$

$${G}_{m} ( s ) = γ {e}^{- s τ l} \frac{1 - {e}^{- s {τ}_{d}}}{{τ}_{d}} , \qquad ( 25 )$$

$${G}_{f} ( s ) = βγ {e}^{- s τ l} ( α + \frac{1 - {e}^{- s {τ}_{d}}}{{τ}_{d}} ) , \qquad ( 26 )$$

$${G}_{c 0} ( s ) = α ( 1 - γ ( 1 - β ) ) {e}^{- s {τ}_{l}} , \qquad ( 27 )$$

$${G}_{c} ( s ) = α ( 1 - γ ) {e}^{- s {τ}_{c}} , \qquad ( 28 )$$

$${D}_{0} ( s ) = s - ( 1 - β ) {G}_{m} ( s ) + {G}_{c 0} , \qquad ( 29 )$$

$$D ( s ) = s - {G}_{m} ( s ) + {G}_{f} ( s ) + {G}_{c} ( s ) . \qquad ( 30 )$$

The position transfer functions Tᵢ(s) in Equation (16) for the follower vehicles i≥2 are given by

$${T}_{i} ( s ) = [ \frac{{G}_{c} ( s )}{D ( s )} {{\sum }_{j = 0}}^{i - 2} {( \frac{{G}_{f} ( s )}{D ( s )} )}^{j} ] + {( \frac{{G}_{f} ( s )}{D ( s )} )}^{i - 1} {T}_{1} ( s ) , \qquad ( 31 )$$

where T₁(s) is the lead-vehicle transfer function in Equation (23).

The CVS can be made internally stable if the delays in the vehicle control are small compared to the CVS time constant. The internal stability of the CVS protocol is independent of the DSR delay τ_{d} if the DSR gain β is selected as

$$β = 1. \qquad ( 35 )$$

Moreover, with this DSR-gain selection, the CVS with the blended protocol in Equation (15) can always be stabilized if the local sensing delay τₗ and the communication delay τ_{c} are small compared to the CVS time constant

$$1 / α ,$$

$$max \{ {τ}_{l} , {τ}_{c} \} < \frac{π}{2} ( \frac{1}{α} ) . \qquad ( 36 )$$

There is no imaginary axis crossing of the poles under the condition in Equation (36), resulting in internal stability of the CVS. Internal stability is guaranteed when both the local sensing delay τₗ and the communication delay τ_{c} are bounded as in Equation (36), and for larger communication delays, the internal stability of the CVS can still be guaranteed by using a sufficiently large blending gain, γ.

The CVS with the blended protocol in Equation (15) is internally stable, for any communication delay τ_{c}, if the local sensing delay τₗ and the blending gain γ satisfy

$${τ}_{l} < \frac{π}{2 α} , \qquad ( 53 )$$

$$\frac{1}{1 + cos ( {τ}_{l} α )} < γ \leq 1 \qquad ( 54 )$$

with the DSR gain β=1 as in Equation (35).

The CVS is internally stable for any selection of the blending gain γ∈[0, 1] if the communication delay τ_{c} and local-sensing delay τₗ are small with respect to the time constant

$$1 / α ,$$

i.e., smaller than

$$π / ( 2 α ) ,$$

sufficient use of the DSR input u_{dsr} (with a sufficiently large blending gain as in Equation (54)) also ensures internal stability. Based on the above, the remainder of the discussion herein assumes that the CVS is internally stable by satisfying the stability conditions above, including β=1.

String stability: The CVS is said to be string stable if spacing errors do not amplify along the vehicle platoon 200 downstream, i.e., the magnitudes of the error propagation transfer functions Gᵢ(s) of the follower vehicles (i≥2) satisfy

$$\vert {G}_{i} ( j ω ) = \frac{{δ}_{i + 1} ( s )}{{δ}_{i} ( s )} \vert < 1 , ∀ ω > 0 , \qquad ( 17 )$$

where the spacing error δᵢ is defined as

$${δ}_{i} ( s ) = {x}_{i - 1} ( s ) - {x}_{i} ( s ) . \qquad ( 18 )$$

To assess string stability, the error propagation transfer functions Gᵢ, ∀ᵢ∈ [symbol] are obtained using the definition of the spacing error in Equation (18) and the position transfer functions Tᵢ in Equation (16), as for i=1,

$${G}_{1} ( s ) = \frac{{x}_{1} ( s ) - {x}_{2} ( s )}{{x}_{0} ( s ) - {x}_{1} ( s )} = \frac{{T}_{1} ( s ) - {T}_{2} ( s )}{1 - {T}_{1} ( s )} , \qquad ( 56 )$$

$$and for i \geq 2 ,$$

$${G}_{i} ( s ) = \frac{{x}_{i} ( s ) - {x}_{i + 1} ( s )}{{x}_{i - 1} ( s ) - {x}_{i} ( s )} = \frac{{T}_{i} ( s ) - {T}_{i + 1} ( s )}{{T}_{i - 1} ( s ) - {T}_{i} ( s )} . \qquad ( 57 )$$

The CVS can be made string stable if the delays in the vehicle control are small. The CVS, with the blended protocol in Equation (15) satisfying the internal stability conditions above, meets the string stability condition in Equation (17) on the error-propagation transfer function Gᵢ(s) provided the time delays in local sensing τₗ, communication τ_{c}, and DSR τ_{d} are sufficiently small compared to the time constant

$$1 / α$$

of the CVS, and the blending gain is less than one

$$γ < 1. \qquad ( 58 )$$

This ensures string stability if the delays are small. The CVS, with the blended protocol in Equation (15) satisfying the internal stability conditions as discussed above, meets the string stability condition in Equation (17) on the error-propagation transfer function Gᵢ(s) provided the minimum value of f(ω) over the bounded interval [0, ω*] is positive, i.e.,

$${min}_{ω ∈ ( 0 , {ω}^{*} ]} f ( ω , γ , {τ}_{c} ) > 0 , \qquad ( 69 )$$

$$where$$

$${ω}^{*} = α ( 1 + 2 \sqrt{\frac{1}{3} + \frac{{ατ}_{d} + 1}{{α}^{2} {τ}_{d}^{2}}} ) . \qquad ( 70 )$$

Based on the above, the remainder of the discussion herein assumes that the CVS is string stable by satisfying the stability conditions above, including γ<1.

Steady-state error: Given a step change in the desired velocity, i.e. v₀(s)=V/s, the CVS has no steady state error if the spacing error δᵢ in Equation (18) converges to zero for all vehicles, i.e.,

$${lim}_{t \to ∞} {δ}_{i} ( t ) = {lim}_{s \to ∞} s {δ}_{i} ( s ) = 0 ∀ i ∈ 𝒩 . \qquad ( 19 )$$

Embodiments of the present disclosure maintain constant steady-state spacing between vehicles, by using the blended protocol in Equation (15) satisfying the internal stability conditions discussed above. Specifically, with desired trajectory x₀(s)=Vt and

$${x}_{0} ( s ) = {v}_{0} ( s ) / s = V / {s}^{2} \qquad ( 73 )$$

the relative spacing error δᵢ is zero, lim_{t→∞}δᵢ(t)=0, for all follower vehicles, i.e., i≥2.

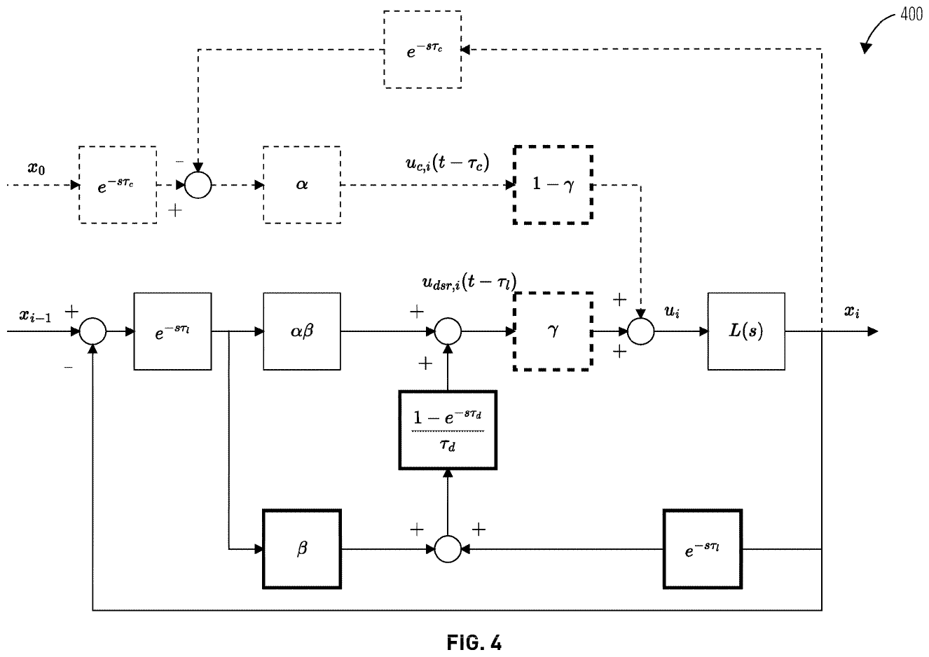

FIG. 4 is a schematic illustration of the predecessor-leader-follower (PLF) with delayed-self-reinforcement (DSR) control strategy for follower vehicles in a vehicle platoon according to various aspects of the present disclosure. The control strategy 400 is suitable for follower vehicles i≥2 from Equation (22) (i.e., follower vehicles behind first follower vehicle 204, wherein first follower vehicle 204 is directly following lead vehicle 202). The control strategy 400 considers communication delay τ_{c}, local sensing delay τₗ, and DSR delay τ_{d}. The vehicle control u_{c,i} using centralized information is depicted in dashed lines, and the control u_{dsr,i} using decentralized sensing is in solid line. The DSR augmentation of more traditional feedback systems are shown the bold solid line blocks, and the blending of centralized and decentralized control is shown in bold dashed blocks. In some embodiments, when centralized communication is lost, u_{c,i} may be set to zero. For PLF without DSR, the bold solid-line blocks are set to zero, and the bold dashed-line blocks are set to 1.

In some situations, the blended technique used by the control strategy 400 falls back to a purely predecessor-follower DSR case (referred to as PF with DSR) for the follower vehicles due to the loss of centralized communication of the desired trajectory, i.e.,

$${\dot{x}}_{i} ( t ) = γ {u}_{ds τ} ( t - {τ}_{l} ) , i \geq 2 \qquad ( 85 )$$

$$\begin{matrix}{\dot{x}}_{1} ( t ) = γ {u}_{ds τ , 1} ( t - {τ}_{l} ) + ( 1 - γ ) {u}_{c , 1} ( t - {τ}_{l} ) \\ = - α ( {x}_{1} ( t - {τ}_{l} ) - {x}_{0} ( t - {τ}_{l} ) )\end{matrix} .$$

As stated above, this is represented in the control strategy 400 illustrated in FIG. 4 by setting the centralized control weights in the bold dashed blocks (i.e., u_{c,i}(t)) to 0.

Without centralized control, constant spacing is difficult to maintain while remaining string stable. However, even under full communication loss, the DSR-based approach to constant spacing platooning remains internally stable and is string stable, as discussed above. The cost of this string stability is an increase in steady state spacing error similar to standard PLF (where the steady state spacing error is proportional to the time constant

$$1 / α$$

and quantified below. The steady state error also decreases with larger values of blending gain γ.

Internal stability is maintained if centralized communication to the follower vehicles is lost as in Equation (85) when the local sensing delay τₗ satisfies the internal stability condition with the centralized communication described above, i.e.,

$${τ}_{l} < \frac{π}{2 α} ,$$

as in Equation (53). String stability is maintained if centralized communication to the followers is lost as in Equation (85) when satisfying the string stability condition γ<1 in Equation (58) and satisfying the internal stability conditions above, provided the blending gain γ>0 is sufficiently small, i.e.,

$$0 < γ < {γ}^{*} = \frac{- {ατ}_{l} + \sqrt{{α}^{2} {τ}_{l}^{2} + {ατ}_{d} + 1}}{{ατ}_{d} + 1} , \qquad ( 88 )$$

where the upper bound γ* is less than one.

When communication to the followers is lost, the relative spacing error of the i^{th} vehicle at the steady state for the desired trajectory in Equation (73) is given as

$${lim}_{s \to 0} s {δ}_{i} ( s ) = \frac{V}{α} ( \frac{1}{γ} - 1 ) . \qquad ( 92 )$$

Based on the above, string stability and constant spacing are not simultaneously guaranteed when communication is lost. The relative spacing error converges to zero when the blending gain γ=1 from Equation (92). However, string stability uses a smaller blending gain γ<γ*<1 from Equation (88).

Accordingly, the standard first-order protocol for constant spacing without DSR can be derived as follows, along with conditions for internal stability and string stability, while quantifying the steady-state error.

The standard protocol for first-order constant spacing tracking, referred to as PLF without DSR, is given as

$${\dot{x}}_{i} ( t ) = {u}_{std , i} ( t - {τ}_{l} ) + {u}_{c , i} ( t - {τ}_{c} ) , ∀ i \geq 2 \qquad ( 97 )$$

$${\dot{x}}_{1} ( t ) = {u}_{std , 1} ( t - {τ}_{l} ) ,$$

where u_{std,i}(t)=α(xᵢ₋₁(t)−xᵢ(t)). Similarly, when the second term in Equation (97) for i≥2 is dropped due to communication loss, the technique is referred to as PF without DSR in the following discussion. The PLF without DSR corresponds to FIG. 4 with the solid blocks removed, β=1, and the gains of both of the bold dashed blocks (γ and 1−γ) set to 1. Since the position transfer function of the standard protocol in Equation (97) has the same general form as Equation (24), arguments similar to the DSR case can be used to establish internal stability if the delays are small, and the ability to maintain constant spacing. To enable comparison with DSR, the condition to check for string stability is established below. In particular, using techniques similar to the DSR case, the error transfer function of the PLF without DSR in Equation (97) can be written as

$${G}_{i} ( s ) = \frac{α {e}^{- s {τ}_{l}}}{s + α ( {e}^{- s {τ}_{l}} + {e}^{- s {τ}_{c}} )} = G ( s ) . \qquad ( 98 )$$

Combining this with Equation (17), string stability involves

$$\vert G ( j ω ) \vert = \vert \frac{α {e}^{- j ω {τ}_{l}}}{j ω + α ( {e}^{- j ω {τ}_{l}} + {e}^{- j ω {τ}_{c}} )} \vert < 1 , ∀ ω > 0 , \qquad ( 99 )$$

which is equivalent to using, for ω>0,

$$f ( ω , {τ}_{c} ) = \vert j ω + α ( {e}^{- j ω {τ}_{l}} + {e}^{- j ω {τ}_{c}} ) {\vert}^{2} - {\vert α {e}^{- j ω {τ}_{l}} \vert}^{2} = \vert j ω + α ( {e}^{- j ω {τ}_{l}} + {e}^{- j ω {τ}_{c}} ) {\vert}^{2} - {α}^{2} > 0. \qquad ( 100 )$$

The CVS, with the standard protocol in Equation (97), meets the string stability condition in Equation (17) on the error-propagation transfer function Gᵢ(s), provided the minimum value of f(ω) in Equation (100) is positive over the bounded interval [0, ω*], i.e., with ω*=4α,

$${min}_{ω ∈ ( 0 , {ω}^{*} ]} f ( ω , {τ}_{c} ) > 0. \qquad ( 101 )$$

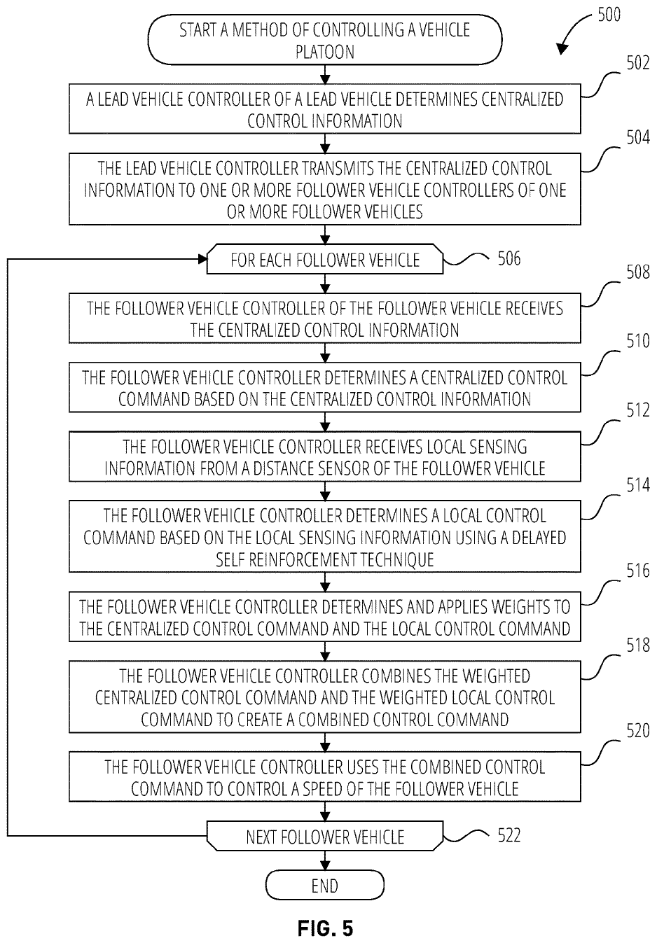

FIG. 5 is a flowchart that illustrates a non-limiting example embodiment of a method of controlling a vehicle platoon according to various aspects of the present disclosure. In the method 500, the techniques described above and illustrated in FIG. 4 are used to blend centralized control with local control using a delayed self reinforcement technique that maintains internal stability, string stability, and constant steady-state spacing.

From a start block, the method 500 proceeds to block 502, where a lead vehicle controller of a lead vehicle 202 determines centralized control information. In some embodiments, the lead vehicle controller is implemented by logic executed by the ECU 106 of the lead vehicle 202. In some embodiments, the centralized control information may include a desired location of the lead vehicle 202 at a given time.

At block 504, the lead vehicle controller transmits the centralized control information to one or more follower vehicle controllers of one or more follower vehicles. In some embodiments, the lead vehicle controller uses the V2V interface 112 to transmit the centralized control information to the follower vehicles in the vehicle platoon 200. In some embodiments, the lead vehicle controller uses the V2V interface 112 to transmit the centralized control information to the first follower vehicle 204, the first follower vehicle 204 may in turn pass the centralized control information to the second follower vehicle 206, and so on throughout the vehicle platoon 200.

The method 500 then proceeds to a for-loop defined between a for-loop start block 506 and a for-loop end block 522, wherein the control techniques described above are applied by each of the follower vehicles. From the for-loop start block 506, the method 500 proceeds to block 508, where the follower vehicle controller of the follower vehicle receives the centralized control information. As with the lead vehicle controller, in some embodiments, the follower vehicle controller is implemented by logic executed by the ECU 106 of the follower vehicle.

At block 510, the follower vehicle controller determines a centralized control command based on the centralized control information. In some embodiments, the centralized control command is a desired location for the follower vehicle that may be determined based on the desired location of the lead vehicle 202 as indicated by the centralized control information, a communication delay, and the rank i of the follower vehicle within the vehicle platoon 200 (e.g., u_{c,i}(t−τ_{c}) from FIG. 4).

At block 512, the follower vehicle controller receives local sensing information from a distance sensor of the follower vehicle. In some embodiments, the local sensing information may be received from one or more long-range sensors 108, one or more short-range sensors 110, and/or combinations thereof, and represents a relative positioning error for the follower vehicle with respect to its predecessor vehicle.

At block 514, the follower vehicle controller determines a local control command based on the local sensing information using a delayed self reinforcement (DSR) technique. As illustrated in FIG. 4, the local control command is a desired location for the follower vehicle based on the local sensing information, a communication delay, and a local sensing delay (e.g., u_{dsr,i}(t−τₗ)).

At block 516, the follower vehicle controller determines and applies weights to the centralized control command and the local control command. Any appropriate values may be used for the weights (the blending gain γ, or gamma, illustrated in FIG. 4, which is applied as a weight to the local control command, and is applied as 1−γ to the centralized control command). Increasing the blending gain γ causes more reliance on the local control command than the centralized control command.

Selecting larger values for the blending gain γ reduces the reliance on the centralized control command, and therefore increases the acceptable communication delay τ_{c} for internal stability. For example, one non-limiting example of an acceptable communication delay for internal stability is given as

$${τ}_{c} < π / 2 α \approx 3.92 s .$$

However, increasing the blending gain γ such that

$$γ > \frac{1}{1 + cos ( {τ}_{l} α )} \approx 0.5 ,$$

ensures internal stability regardless of the communication delay τ_{c}.

Selecting larger values for the blending gain γ also reduces the acceptable communication delay τ_{c} for string stability. This is expected since sufficient centralized command is desirable to make constant-spacing PLF string stable, and pure decentralized DSR (γ=1) has difficulties maintaining string stability. Given a target acceptable communication delay

$${τ}_{c}^{*}$$

for string stability, the candidate set of all the available blending gain S_{γ} can be solved numerically via the following expression:

$$S γ = \{ γ ∈ [ 0 , 1 ] \vert {min}_{ω ∈ ( 0 , {ω}^{*} ]} f ( ω , γ , {τ}_{c}^{*} ) > 0 \} , \qquad ( 105 )$$

$${ω}^{*} = α ( 1 + 2 \sqrt{650.3} ) = 20.8 rad / s .$$

with f(ω, γ, τ_{c}) defined as

$$f ( ω , γ , {τ}_{c} ) = {\vert {τ}_{d} ( j ω + α ( γ {e}^{- j ω {τ}_{l}} + ( 1 - γ ) {e}^{- j ω {τ}_{c}} ) ) \vert}^{2} - {\vert {e}^{- j ω {τ}_{l}} γ ( {ατ}_{d} + 1 - {e}^{- j ω {τ}_{d}} ) \vert}^{2} = {{α}^{2} ( 1 - γ )}^{2} {τ}_{d}^{2} + 2 {α}^{2} {τ}_{d}^{2} γ ( 1 - γ ) cos ( ( {τ}_{c} - {τ}_{l} ) ω ) + {τ}_{c}^{2} {ω}^{2} - 2 {τ}_{d}^{2} α ω ( γ sin ( {τ}_{l} ω ) + ( 1 - γ ) sin ( {τ}_{c} ω ) ) - 2 {γ}^{2} ( α {τ}_{d} + 1 ) ( 1 - cos ( {τ}_{c} ω ) ) > 0. \qquad ( 62 )$$

The range of the candidate set S_{γ} reduces as the communication delay τ_{c} increases.

Accordingly, the blending gain γ may be selected so that the acceptable communication delay

$${τ}_{c}^{*}$$

for string stability is the same for PLF, with and without DSR. For PLF without DSR, the acceptable communication delay

$${τ}_{c}^{*}$$

for string stability can be solved numerically via the following expression:

$${τ}_{c}^{*} = {sup}_{{τ}_{c} > 0} {min}_{ω ∈ ( 0 , {ω}^{*} ]} f ( ω , {τ}_{c} ) > 0 , {ω}^{*} = 4 α = 1.6 rad / s , \qquad ( 106 )$$

with f(ω, τ_{c}) from Equation (100). From Equation (106), the acceptable communication delay for string stability is solved as

$${τ}_{c}^{*} = 2.68 s .$$

To achieve the same acceptable communication delay for PLF with DSR, the candidate set S_{γ} can be solved as 0≤γ≤0.83 numerically by substituting

$${τ}_{c}^{*} = 2.68 s$$

into Equation (105). The largest value of γ=0.83 may be selected for PLF with DSR since this selection reduces the steady-state error when the communication is lost. Lastly, choosing γ=0.83 guarantees string stability when the communication is lost, with

$$γ = 0.83 < {γ}^{*} = \frac{{ατ}_{l} + \sqrt{{α}^{2} {τ}_{l}^{2} + {ατ}_{d} + 1}}{{ατ}_{d} + 1} = 0.94 , \qquad ( 107 )$$

where the upper bound γ*=0.94 is computed from Equation (88).

At block 518, the follower vehicle controller combines the weighted centralized control command and the weighted local control command to create a combined control command, and at block 520, the follower vehicle controller uses the combined control command to control a speed of the follower vehicle. The combined control command may represent a desired location for the follower vehicle, and the follower vehicle controller may use a representation of the vehicle dynamics for the follower vehicle (such as that illustrated in FIG. 3) to determine an adjustment to the speed of the follower vehicle in order to reach the desired location in the vehicle platoon 200. The follower vehicle controller may transmit an appropriate command based on the determined adjustment to the speed to a speed controller or other component of the follower vehicle, such that actions are taken by components of the powertrain 104 to cause the command to be implemented and the speed of the follower vehicle to change per the command. In some embodiments, the follower vehicle controller may provide the desired location to the speed controller, and the speed controller may determine the appropriate commands to be transmitted to the powertrain 104 to cause the desired location to be reached.

The method 500 then advances to the for-loop end block 522. If other follower vehicles are present in the vehicle platoon 200, then the method 500 returns to the for-loop start block 506 for the next follower vehicle to conduct the control technique. Otherwise, if all of the follower vehicles have applied the control technique, then the method 500 advances from the for-loop end block 522 to an end block and terminates. Though illustrated as ending, one of skill in the art will recognize that in some embodiments, the method 500 loops continuously from the end block to the start block while the vehicles continue to operate as a vehicle platoon 200. Further, one of skill in the art will recognize that while the actions of the follower vehicles are described as happening in series for ease of illustration, in some embodiments, two or more (or all) of the follower vehicles may perform the actions of the for-loop in parallel.

### Simulation Results

Simulations with typical CVS parameters from literature were used to illustrate the impact of control parameter selections such as blending gain γ as well as DSR gain β, and to estimate the benefits of using the proposed DSR method.

The performance of PLF with DSR (Equation (15)) was evaluated using the MATLAB/Simulink environment. The simulations included the CVS with one lead vehicle 202 and four follower vehicles. Different methods were evaluated for a step change in the target velocity, with the vehicle platoon 200 accelerating from static to the target velocity of V=20 m/s. Except for the communication delay τ_{c} and the blending gain γ, the rest of the parameters were selected as typical CVS values, as discussed below.

For control gain α, depending on the types of the vehicles, the target settling time for accelerating from V=0 to V=20 m/s varies from 5 to 10 s for typical automobile cruise control systems on passenger cars, to 10 to 30 s for heavy duty trucks. In the simulations described herein, a control gain α of α=0.4 was chosen to match the settling time of 10 s.

As for local sensing delay τₗ and DSR delay τ_{d}, the local sensing delay depends on the update rate of the distance sensors and the processors. Typically, the local sensor sensing delay τₗ varies between 0.1 to 0.3 s. In the simulations described herein, the DSR delay τ_{d} is set to be the same as the local sensing delay, τ_{d}=τₗ=0.1 s. This delay was selected to match an update rate of a Bosch Mid Range Radar (MRR) sensor, which is widely used in vehicles with Advanced Driver Assistance Systems (ADAS). The controller also outputs the discrete control signal with the sampling time as τ_{d}=0.1 s.

The individual vehicle dynamics was selected as a double integrator model, e.g.,

$${\tilde{L}}_{i} ( s ) = \frac{1}{{s}^{2}} ,$$

and according to Equations (3) and (4), the feedback controllers are selected as

$${C}_{ff , i} ( s ) + 10 α , {C}_{fn , i} ( s ) + 10 α s , \qquad ( 103 )$$

with k₁=10α=4 for the feedforward controller C_{ff,i}(s) to have a higher bandwidth (by a decade) compared to the velocity dynamics. Note that the choice of k₁=4 also ensures that the canceled pole s=−4 is stable. For real-time simulations, the controller does not have direct access to the derivative of the relative spacing through local sensing. Therefore, a low-pass filter with cutoff frequency ω_{f}=40α=16 rad/s was added to prevent the amplification of the high frequency noise during computations of the derivative, which results in a modified feedforward controller

$${C}_{ff , i} ( s ) = \frac{{ω}_{f}}{( s + {ω}_{f} )} ( s + 10 α ) .$$

To evaluate the convergence speed to steady-state, the settling time Tₛ of the CVS is defined as the minimum time required for the states of all of the vehicles of the vehicle platoon 200 to settle and remain within 2% of the final steady-state values. Besides, in order to evaluate the ability to maintain constant-spacing during the transient process, the maximum deviation δₘ of the CVS is defined by

$${δ}_{m} = {max}_{t \geq 0} {‖ X ( t ) - {x}_{0} ( t ) {1}_{n} ‖}_{∞} , \qquad ( 104 )$$

where the vector 1ₙ=[1, . . . , 1]∈ [symbol] . The step response is selected as the source signal for computing the settling time and comparing the spacing error response.

Simulations demonstrated that the use of DSR improves CVS performance, with robustness to large communication delays. Moreover, it was shown that the spacing error is reduced substantially by use of DSR when communication is lost. The proposed PLF with DSR enables both string stability and constant spacing, similar to the PLF without DSR in the presence of typical communication delays. In particular, with a communication delay of τ_{c}=0.5 s, the maximum deviation δₘ for the PLF with DSR during the transition is 2.37 m, compared to the maximum deviation δₘ=2.77 m for the PLF without DSR. The maximum spacing errors during transients in both cases are less than 10 m, which is typically acceptable for CSP CVS systems in literature. The settling time Tₛ for both methods are 9.4 s, which achieves the target settling time of 10 s. Therefore, both PLF with DSR and PLF without DSR have acceptable performance under typical communication delays.

The PLF with DSR has more robust performance to large communication delays, i.e., maintains constant steady-state spacing with similar convergence rate and the maximum transient deviation as the typical-communication delay case. In contrast, the PLF without DSR results in substantial increase in the settling time Tₛ and the maximum deviation δₘ as the communication delay τ_{c} increases. The settling time Tₛ for the PLF with DSR approach changed from 9.4 s (τ_{c}=0.1 s) to 10.7 s (τ_{c}=2.5 s). In contrast, for the PLF without DSR, the settling time Tₛ changed from 9.4 s (τ_{c}=0.1 s) to 35.5 s (τ_{c}=2.5 s). Therefore, the variation of the settling time with DSR (1.3 s) was about 95% less than the variation of the settling time without DSR (26.1 s). Furthermore, the maximum transient deviation δₘ of the PLF with DSR was 4.69 m, which is 74.05% less than the maximum transient deviation δₘ 18.11 m of the PLF without DSR. Therefore, the tracking performance of the proposed PLF with DSR approach was shown in the simulations to be more robust to large centralized delay compared with the PLF without DSR.

When communication is lost, the proposed PF with DSR was shown in the simulations to have better tracking performance compared to PF without DSR. The maximum deviation δₘ with DSR approach was 10.22 m, which was an increase of about 0.5 s headway time. This numerically obtained value of 10.22 m is also close to the predicted steady-state error from Equation (92) given by

$${lim}_{s \to 0} s {δ}_{i} ( s ) = \frac{V}{α} ( \frac{1}{γ} - 1 ) = \frac{20}{0.4} ( \frac{1}{0.83} - 1 ) = 10.24 .$$

In contrast, with communication loss, the maximum deviation δₘ was 50 m without DSR, which was about 2.5 s headway time. The speed-dependent spacing error with DSR (10.22 m) was about 80% less than the speed-dependent spacing error without DSR (50 m). Thus, the PF with DSR was able to maintain small inter-vehicle spacing in the simulated platoon even without communication.

The impact of varying the DSR gain β on the CVS performance was also studied for different communication delay conditions. Overall, the performance of the proposed DSR approach was improved further by increasing the DSR gain, i.e., when β>1. However, the CVS also showed a tendency to become string unstable with larger DSR gain β. In particular, when the communication delay was small (τ_{c}=0.1 s), the maximum deviation δₘ could be further reduced to 0.80 m (with β=1.2) from δₘ=4.15 m (with β=1) and the settling time Tₛ could be further reduced as well to 10.67 s (with β=1.2) from Tₛ=10.87 s (with β=1). The results are similar when communication is lost: The maximum deviation δₘ could be further reduced to 8.53 m (with β=1.2) from δₘ=10.24 m (with β=1) and the settling time Tₛ could be further reduced as well to 14.37 s (with β=1.2) from Tₛ=15.21 s (with β=1). In all cases, the maximum deviation δₘ improves (by up to 20%) with increasing DSR gain β, but the improvement is limited by the eventual advent of string instability at even higher values.

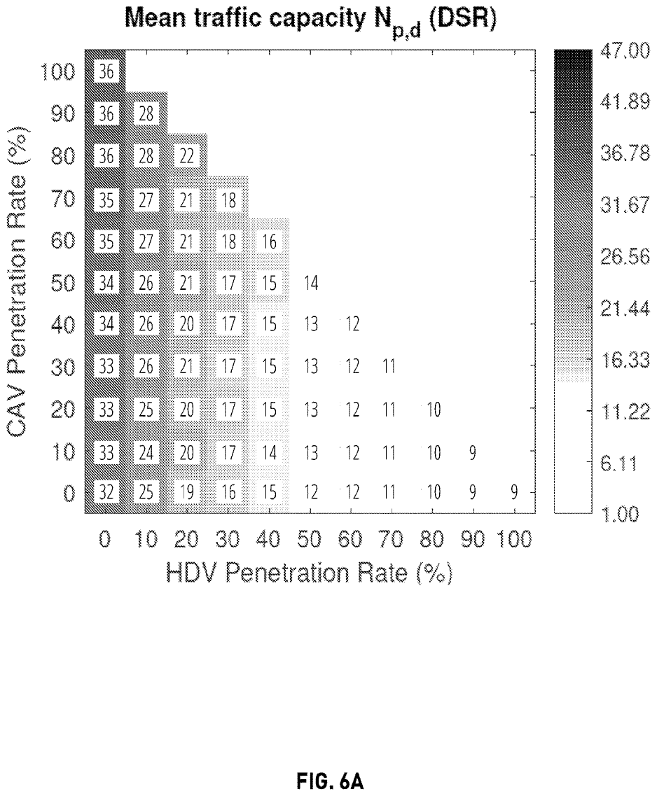

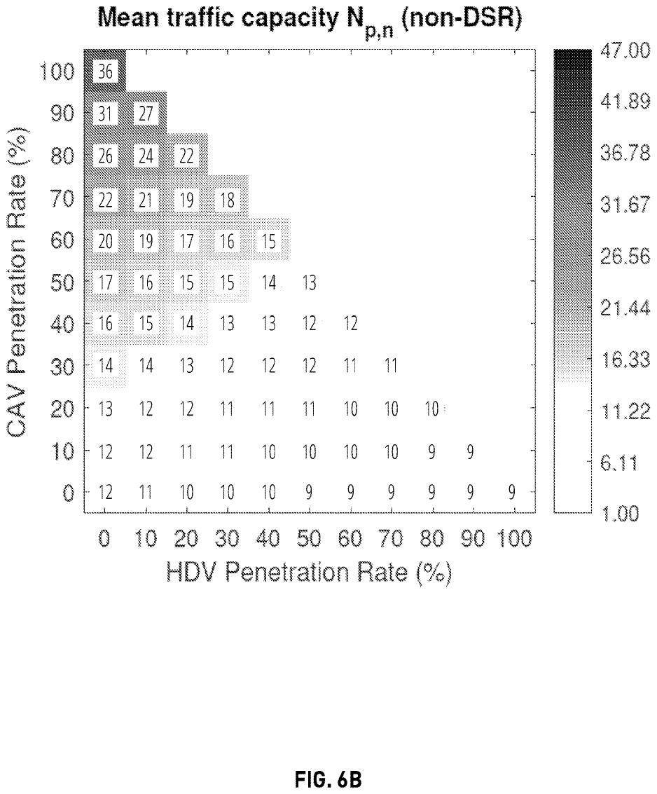

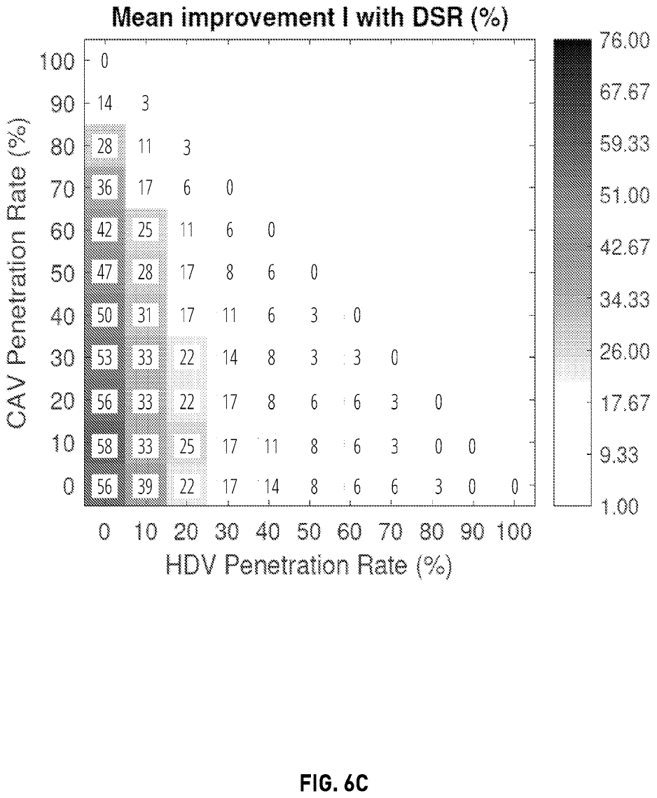

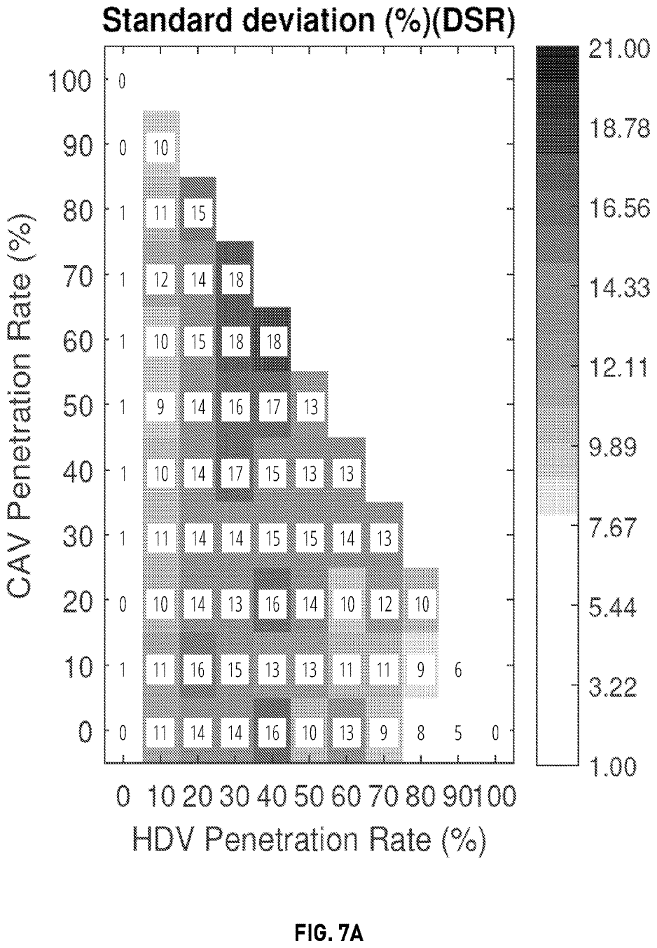

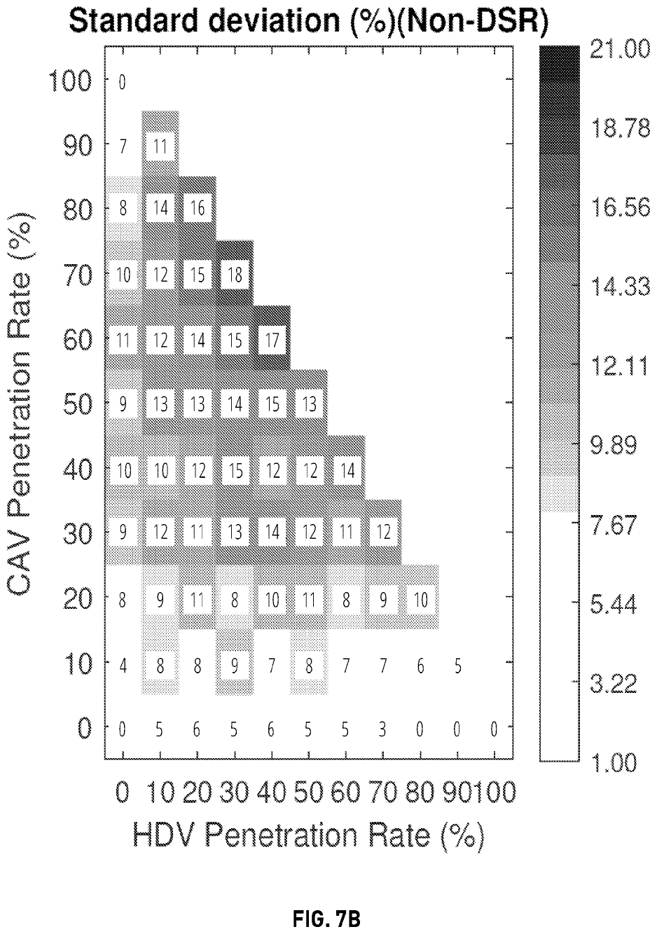

Additional simulation was performed for using these techniques for managing a vehicle platoon 200 in mixed traffic, where the vehicle platoon 200 is a group of autonomous vehicles (AVs) without V2I communication (versus autonomous vehicles with V2I communication, or CAVs) operating alongside human-driven vehicles (HDVs), particularly with respect to throughput through intersections. The human driven vehicles were modeled using a technique disclosed in D. Salles et al., “Extending the intelligent driver model in sumo and verifying the drive off trajectories with aerial measurements,” SUMO User Conference, 2020, the entire disclosure of which is hereby incorporated by reference herein for all purposes. FIG. 6A-FIG. 6C are charts that illustrate simulated mixed traffic capacity with V=34 mph. The use of DSR on AVs improved the traffic capacity of a mixed network, with different market-penetration rate of HDVs and CAVs. The level of improvements decreased as the market-penetration rate of HDVs increased. However, the use of DSR guaranteed improvements on the traffic capacity Nₚ when the mixed traffic had at least 20% AVs, or no more than 80% HDVs, as illustrated in FIG. 6A-FIG. 6C. Specifically, when the mixed traffic had 30% CAVs, 30% HDVs and 40% AVs, the average improvements I from the use of DSR on AVs was 14% of the ideal capacity; when the mixed traffic had 30% AVs, the average improvement I from the use of DSR varied from 6%-36%. The capacity improvement when using DSR was also not impacted significantly by the order of different types of vehicles in the network, since the standard deviation showed that the traffic capacity varied within 18% of the mean capacity with different orders of vehicles, as illustrated in FIG. 7A and FIG. 7B. Therefore, the use of DSR on AVs was shown to improve the traffic capacity Nₚ on various market-penetration rate of HDVs and CAVs.

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern.

The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, 10 when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

It will be appreciated that, although specific embodiments of the disclosure have been described herein for purposes of illustration, various modifications may be made without deviating from the spirit and scope of the disclosure. Accordingly, the disclosure is not limited except as by the claims.

### EXAMPLES

A collection of non-limiting example embodiments follows:

Example 1: A control system for a vehicle platoon, the control system comprising: a lead vehicle controller installed in a lead vehicle; and one or more follower vehicle controllers; wherein the lead vehicle controller is configured to: determine centralized control information; and transmit the centralized control information to the one or more follower vehicle controllers; and wherein each of the one or more follower vehicle controllers is installed in a corresponding follower vehicle and is configured to: receive the centralized control information from the lead vehicle controller; determine a centralized control command based on the centralized control information; receive local sensing information from a distance sensor of the corresponding follower vehicle; determine a local control command based on the local sensing information using a delayed self reinforcement (DSR) technique; apply weights to the centralized control command and the local control command; combine the weighted centralized control command and the weighted local control command to create a combined control command; and use the combined control command to control a speed of the corresponding follower vehicle.

Example 2: The control system of Example 1, wherein applying weights to the centralized control command and the local control command includes: adjusting the centralized control command using a gamma value; and adjusting the local control command using a difference between one and the gamma value.

Example 3: The control system of Example 2, wherein the gamma value is determined based on a value representing a responsiveness of the follower vehicle to speed adjustment commands and a value representing a delay in obtaining the local sensing information.

Example 4: The control system of any one of Example 1 to Example 3, wherein the local sensing information represents a distance between the corresponding follower vehicle and a predecessor vehicle.

Example 5: The control system of any one of Example 1 to Example 4, wherein the combined control command represents a desired location of the corresponding follower vehicle; and wherein using the combined control command to control the speed of the corresponding follower vehicle includes providing the desired location to a speed controller of the corresponding follower vehicle.

Example 6: A method of controlling a follower vehicle in a vehicle platoon, the method comprising: determining, by a follower vehicle controller in the follower vehicle, a centralized control command based on centralized control information; determining, by the follower vehicle controller, a local control command based on local sensing information using a delayed self reinforcement (DSR) technique; applying, by the follower vehicle controller, weights to the centralized control command and the local control command; combining, by the follower vehicle controller, the weighted centralized control command and the weighted local control command to create a combined control command; and using, by the follower vehicle controller, the combined control command to control a speed of the corresponding follower vehicle.

Example 7: The method of Example 6, further comprising receiving the centralized control information from a lead vehicle controller in a lead vehicle.

Example 8: The method of any one of Example 6 to Example 7, wherein the local sensing information represents a distance between the follower vehicle and a predecessor vehicle.

Example 9: The method of Example 8, further comprising receiving the local sensing information from a distance sensor of the follower vehicle.

Example 10: The method of any one of Example 6 to Example 9, wherein applying weights to the centralized control command and the local control command includes: adjusting the centralized control command using a gamma value; and adjusting the local control command using a difference between one and the gamma value.

Example 11: The method of Example 10, wherein the gamma value is determined based on a value representing a responsiveness of the follower vehicle to speed adjustment commands and a value representing a delay in obtaining the local sensing information.

Example 12: The method of Example 11, wherein the gamma value is determined to ensure string stability and eliminate steady tracking error.

Example 13: The method of any one of Example 6 to Example 12, wherein the combined control command represents a desired location of the follower vehicle; and wherein using the combined control command to control the speed of the follower vehicle includes providing the desired location to a speed controller of the follower vehicle.

Example 14: A non-transitory computer-readable medium having computer-executable instructions stored thereon that, in response to execution by one or more processors of a follower vehicle controller, cause the follower vehicle controller to perform a method as recited in any one of Example 6 to Example 13.

Example 15: A follower vehicle controller configured to perform a method as recited in any one of Example 6 to Example 13.

Example 16: A follower vehicle having a follower vehicle controller as recited in Example 15.

1. A control system for a vehicle platoon, the control system comprising:
a lead vehicle controller installed in a lead vehicle; and
one or more follower vehicle controllers;
wherein the lead vehicle controller is configured to:
determine centralized control information; and
transmit the centralized control information to the one or more follower vehicle controllers; and
wherein each of the one or more follower vehicle controllers is installed in a corresponding follower vehicle and is configured to:
receive the centralized control information from the lead vehicle controller;
determine a centralized control command based on the centralized control information;
receive local sensing information from a distance sensor of the corresponding follower vehicle;
determine a local control command based on the local sensing information using a delayed self reinforcement (DSR) technique;
apply weights to the centralized control command and the local control command;
combine the weighted centralized control command and the weighted local control command to create a combined control command; and
use the combined control command to control a speed of the corresponding follower vehicle.

2. The control system of claim 1, wherein applying weights to the centralized control command and the local control command includes:
adjusting the centralized control command using a gamma value; and
adjusting the local control command using a difference between one and the gamma value.

3. The control system of claim 2, wherein the gamma value is determined based on a value representing a responsiveness of the follower vehicle to speed adjustment commands and a value representing a delay in obtaining the local sensing information.

4. The control system of claim 1, wherein the local sensing information represents a distance between the corresponding follower vehicle and a predecessor vehicle.

5. The control system of claim 1, wherein the combined control command represents a desired location of the corresponding follower vehicle; and
wherein using the combined control command to control the speed of the corresponding follower vehicle includes providing the desired location to a speed controller of the corresponding follower vehicle.

6. A method of controlling a follower vehicle in a vehicle platoon, the method comprising:
determining, by a follower vehicle controller in the follower vehicle, a centralized control command based on centralized control information;
determining, by the follower vehicle controller, a local control command based on local sensing information using a delayed self reinforcement (DSR) technique;
applying, by the follower vehicle controller, weights to the centralized control command and the local control command;
combining, by the follower vehicle controller, the weighted centralized control command and the weighted local control command to create a combined control command; and
using, by the follower vehicle controller, the combined control command to control a speed of the corresponding follower vehicle.

7. The method of claim 6, further comprising receiving the centralized control information from a lead vehicle controller in a lead vehicle.

8. The method of claim 6, wherein the local sensing information represents a distance between the follower vehicle and a predecessor vehicle.

9. The method of claim 8, further comprising receiving the local sensing information from a distance sensor of the follower vehicle.

10. The method of claim 6, wherein applying weights to the centralized control command and the local control command includes:
adjusting the centralized control command using a gamma value; and
adjusting the local control command using a difference between one and the gamma value.

11. The method of claim 10, wherein the gamma value is determined based on a value representing a responsiveness of the follower vehicle to speed adjustment commands and a value representing a delay in obtaining the local sensing information.

12. The method of claim 11, wherein the gamma value is determined to ensure string stability and eliminate steady tracking error.

13. The method of claim 6, wherein the combined control command represents a desired location of the follower vehicle; and
wherein using the combined control command to control the speed of the follower vehicle includes providing the desired location to a speed controller of the follower vehicle.

14. A non-transitory computer-readable medium having computer-executable instructions stored thereon that, in response to execution by one or more processors of a follower vehicle controller in a follower vehicle in a vehicle platoon, cause the follower vehicle controller to perform actions for controlling the follower vehicle, the actions comprising:
determining, by the follower vehicle controller, a centralized control command based on centralized control information;
determining, by the follower vehicle controller, a local control command based on local sensing information using a delayed self reinforcement (DSR) technique;
applying, by the follower vehicle controller, weights to the centralized control command and the local control command;
combining, by the follower vehicle controller, the weighted centralized control command and the weighted local control command to create a combined control command; and
using, by the follower vehicle controller, the combined control command to control a speed of the follower vehicle.

15-16. (canceled)

17. The non-transitory computer-readable medium of claim 14, wherein the actions further comprise receiving the centralized control information from a lead vehicle controller in a lead vehicle.

18. The non-transitory computer-readable medium of claim 14, wherein the local sensing information represents a distance between the follower vehicle and a predecessor vehicle.

19. The non-transitory computer-readable medium of claim 18, further comprising receiving the local sensing information from a distance sensor of the follower vehicle.

20. The non-transitory computer-readable medium of claim 14, wherein applying weights to the centralized control command and the local control command includes:
adjusting the centralized control command using a gamma value; and
adjusting the local control command using a difference between one and the gamma value.

21. The non-transitory computer-readable medium of claim 20, wherein the gamma value is determined based on a value representing a responsiveness of the follower vehicle to speed adjustment commands and a value representing a delay in obtaining the local sensing information.

22. The non-transitory computer-readable medium of claim 14, wherein the combined control command represents a desired location of the follower vehicle; and
wherein using the combined control command to control the speed of the follower vehicle includes providing the desired location to a speed controller of the follower vehicle.
